(19) United States
(12) Patent Application Publication
(10) Pub. No.: US 2009/0228715 A1
(43) Pub. Date: Sep. 10, 2009

(54) MEDIA SECURITY SYSTEM AND METHOD

(75) Inventor: David P. YACH, Waterloo (CA)

Correspondence Address: PERRY + CURRIER INC.;(FOR RIM), 1300 YONGE STREET, SUITE 500, TORONTO, ON, M4T-1X3, CA

(73) Assignee: RESEARCH IN MOTION LIMITED, Waterloo (CA)

(21) Appl. No.: 12/042,654

(22) Filed: Mar. 5, 2008

(51) Int. Cl. G06F 21/00

(52) U.S. Cl. 713/189

(57) ABSTRACT

The present specification provides, amongst other things, a system for offering the capability to asynchronously upload secure media packages to client machines and providing for recovery of the media packages in playable (or other usable form) only at a predefined time, so that the client machines can all access the media packages only at or after the predefined time.

### FIELD

The present specification relates generally to communication and more specifically relates to a media security system and method.

### BACKGROUND

Today, many computer files are not to be released publicly until a specified date and time. Examples include, but are not limited to, company earnings press releases, new movie releases, and first-run television programs. Releasing the content at the proper date and time, as is often done on the web, creates an influx of requests for the content and the download can take significant time as the size of the information grows. In bandwidth constrained connections, such as certain wireless connections, such simultaneous download can significantly strain resources.

### BRIEF DESCRIPTION OF THE DRAWINGS

FIG. 1 is schematic representation of a media security system.

FIG. 2 shows the system of FIG. 1 with specific features according to an embodiment.

FIG. 3 shows a flow-chart depicting a method of generating security tokens.

FIG. 4 shows a flow-chart depicting a method of generating secure media packages.

FIG. 5 shows the system of FIG. 2 during exemplary performance of step 415 in FIG. 4.

FIG. 6 shows the system of FIG. 2 subsequent to performance of method of FIG. 4.

FIG. 7 shows a flow-chart depicting a method of recovering a secure media package.

FIG. 8 shows the system of FIG. 2 during exemplary performance of step 720 of FIG. 7 by client machine 62-2.

FIG. 9 shows the system of FIG. 2 during exemplary performance of step 720 of FIG. 7 by client machine 62-1 and exemplary performance of step 725 of FIG. 7 by client machine 62-2.

### DETAILED DESCRIPTION OF THE EMBODIMENTS

In one aspect, there is provided a security server comprising a computing environment including a module that houses one or more central processing units, volatile memory, persistent memory and a network interface. The security server is configured to generate a plurality of security tokens and time stamps associated with each of the security tokens. The time stamps representing times after generation of the security tokens.

The security server can be further configured to permit a media server access to at least one of the security tokens a time prior to a time identified by the time stamp that is respective to the at least one of the security tokens.

Each security token can be comprised of a public encryption key and a private encryption key and the time stamp. The security server can be configured to permit a media server access to the public encryption key at a time prior to a time Identified by the time stamp that is respective to the public encryption key.

The server can be further configured to only permit client machines to access at least one of the security tokens a time equal to or after a time identified by the time stamp that is respective to the at least one of the security tokens.

Each security token can includes a public encryption key and a private encryption key and the time stamp. The security server can be configured to permit a plurality of client machines to access to the private encryption key at a time equal to or after a time identified by the time stamp that is respective to the private encryption key.

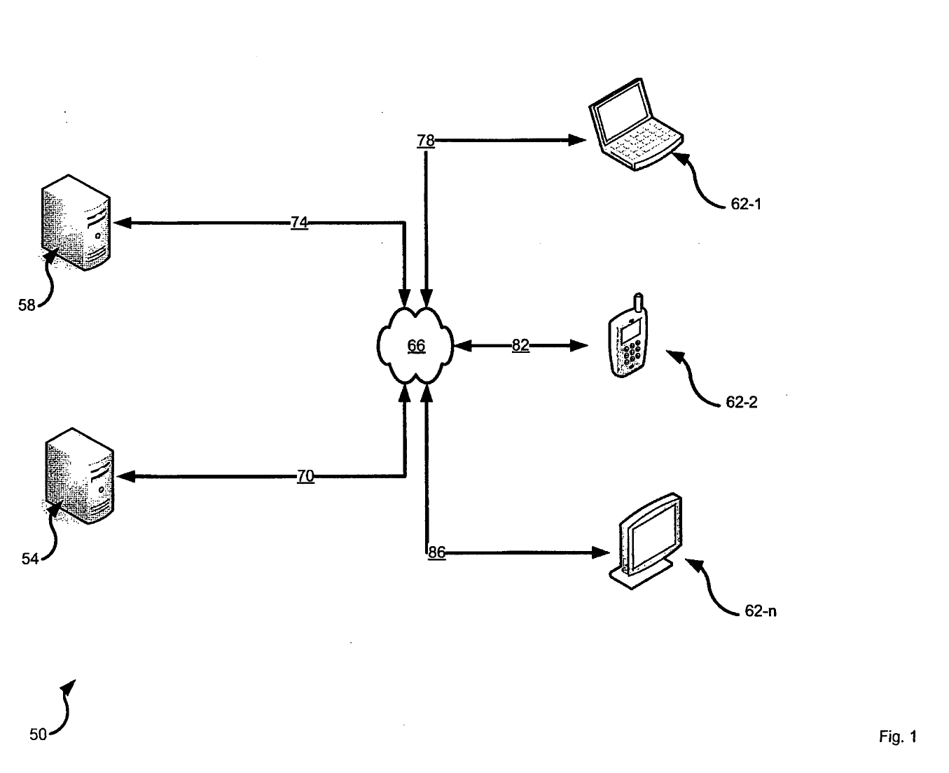

Referring now to FIG. 1, a media security system is indicated generally at 50. System 50 comprises at least one media server 541 at least one security server 58 and a plurality of client machines 62-1, 62-2 . . . 62-n (collectively client machines 62, and generically client machine 62. This nomenclature is used elsewhere herein.) A network 66 interconnects each of the foregoing components.

Media server 54 and security server 58 (which can, if desired, be implemented on a single server) can be based on any well-known server environment including a module that houses one or more central processing units, volatile memory (i.e. random access memory), persistent memory (i.e. hard disk devices) and network interfaces to allow servers 54 and 58 to communicate over network 66. For example, server 54 or server 58 or both can be a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for servers 54 and 58 are contemplated.

Each client machine 62 is typically any type of computing or electronic device that can present media to a user of such a machine 62. For example, in a present embodiment machine 62-1 is a laptop computer having a keyboard and a pointing device (or other input devices or all of the foregoing), a display, speakers, (or other output devices or all of the foregoing) and a chassis to which the keyboard, pointing device, display monitor, speakers are mounted. The chassis also houses one or more central processing units, volatile memory (i.e. random access memory), persistent memory (i.e. flash memory devices) and network interfaces to allow machine 62-1 to communicate over network 66. As another example, client machine 62-2 is a mobile electronic device with the combined functionality of a personal digital assistant, cell phone, email paging device, and a media player. Such a mobile electronic device will thus include its own, albeit smaller, version of the hardware components within machine 62-1, including a keyboard, (or other input devices or both), a display, speakers, (or other output devices or all of the foregoing) and a chassis to which the keyboard, display monitor, speakers are mounted. The chassis also houses one or more central processing units, volatile memory (i.e. random access memory), persistent memory (i.e. hard disk devices) and network interfaces to allow machine 62-2 to communicate over network 66. As another example, client machine 62-n is a television with a digital television signal receiver. Such a television will also include its own version of the hardware components within machine 62-1, including a remote control input device, a screen, speakers and a chassis to which the screen and speakers and an infrared receiver for receiving signals from the remote control is mounted. The chassis can also house the digital television signal receiver which is configured to receive media via network 66 and to present that media on the screen. The digital television signal receiver can also include appropriate software and hardware to authenticate subscriptions associated with client machine 62-n.

It should now be understood that the nature of network 66 is not particularly limited and that network 66 is, in general, based on any combination of network architectures that will support client machines 62 and servers 54 and 58. Accordingly, the links between network 66 and the interconnected components are complementary to functional requirements of those components.

In a present, purely exemplary embodiment, it is contemplated that network 66 will include at least some of the functionality of the Internet. Servers 54 and 58 can thus be configured to support the functionality of a web-server or file-transfer-protocol (“FTP”) server or the like. Accordingly, server 54 will connect to network 66 via a first backhaul link 70 while server 58 will connect to network 66 via a second backhaul link 74. Links 70 and 74 have bandwidth capacity to support content requests from client machines 62.

Client machine 62-1 can be configured to support the functionality of a web-client or FTP client or the like. Accordingly, client 62-2 will connect to network 66 via any standard wired or wireless Internet link 78, such as digital subscriber line (“DSL”), Community Access Television (“CATV”) coaxial cable, Institute of Electrical and Electronic Engineers (IEEE) standard 802.11g (or its variants), Bluetooth or hybrids or combinations or successors thereof or combinations thereof.)

Client machine 62-2 can also be configured to support the functionality of a web-client, FTP client, or a mobile wireless data connection such as General Packet Radio Service (“GPRS”), Enhanced Data rates for Global Evolution (“EDGE”), IEEE standard 802.16, or the like. Accordingly, client 62-2 will connect to network 82 via any wireless link 78 supportive of the foregoing (e.g. GPRS, EDGE, IEEE 802.11g (or its variants), IEEE 802.16, Bluetooth or hybrids or combinations or successors thereof or combinations thereof.)

Client machine 62-n can be configured to support any the functionalities of either client machine 62-1 or client machine 62-2, or configured to support traditional television links such as CATV, or standard land-based or satellite television broadcast or combinations of the foregoing. Accordingly client 62-n will connect to network 66 via a link 86 that is supportive of any of the foregoing.

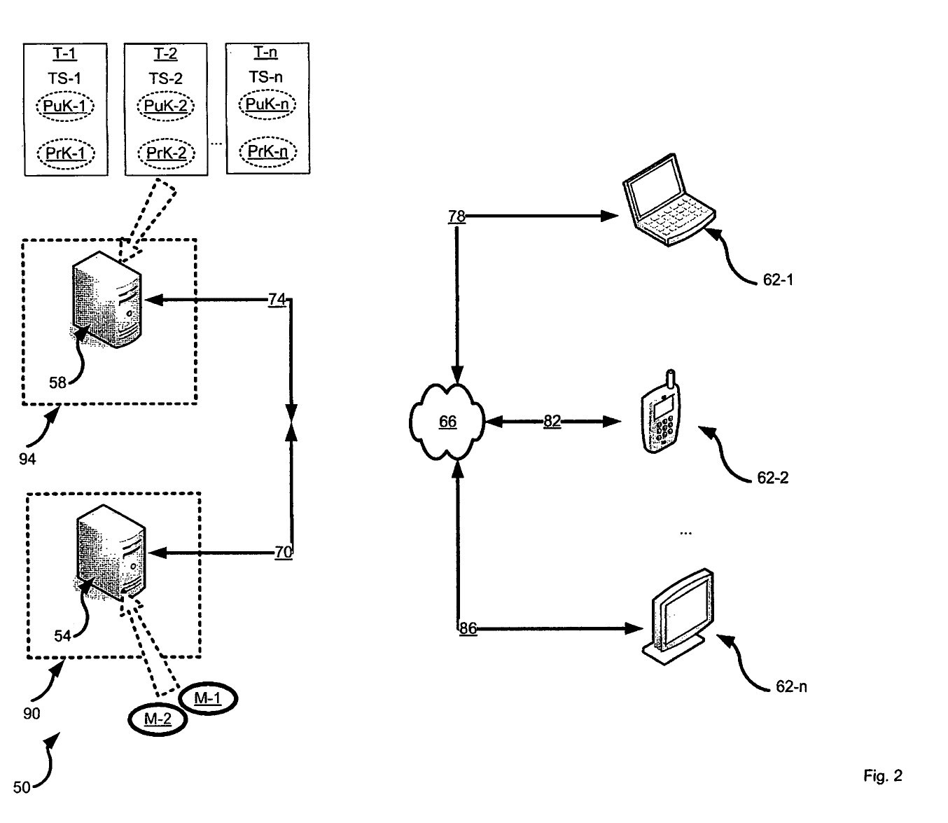

Referring now to FIG. 2, system 50 is shown with additional features according to a present embodiment. In the present embodiment, media server 54 is operated by a media provider 90, while security server 58 is operated by a trusted third-party referred to herein as a security manager 94. (It is to be reemphasized that this is a non-limiting example and there is no reason that servers 54 and 58 cannot be operated by the same entity.) As will be explained, in greater detail below, each client machine 62 is operated by a subscriber that is interested in accessing media stored on server 54.

Media server 54 is configured to maintain media packages M that are intended to only be available to client machines 62 at a predefined time. As will be discussed in greater detail below, media server 54 is also configured to cooperate with security server 58 in order to generate secure versions of media content M such that only those secure versions of media content M are available for download to client machines 62. However, those secure versions of media content M are also made available for download to client machines 62 prior to the predefined time.

In FIG. 2, two media packages M-1, M-2 are represented in the form of ovals. Media packages M can contain media files containing any type of media that is intended for delivery to one or more of client machines 62. Such media packages M can thus contain, for example, press releases, new movie releases, first-run television programs, music files, video games, software or the like. Other types of media that can be stored in media packages M will now occur to those skilled in the art.

In FIG. 2, media packages M are represented as ovals with solid lines. The solid lines represent that media packages M are in a non-secure form meaning that they are immediately playable (or executable or otherwise usable, as the context requires) on client machines 62. In a present embodiment, media packages M are, in this form, maintained by server 54 but not available for delivery (e.g. download) to client machines 62. The fact that media packages M are not available to client machines 62 is represented in FIG. 2 (and where applicable to other Figures) by showing link 70 disconnected from network 66. (It is to be understood that this representation is for convenience in order to assist in explanation).

In FIG. 2, security server 58 is configured to maintain time-stamped security tokens T that can be used to generate secure versions of media packages M and can be used by client machines 62 to recover those secure versions of media packages M into non-secure versions of media packages M. In a present embodiment, security tokens T are implemented using a private and public key pair. (Another alternative implementation could include shared symmetric keys, which could be implemented where media server 54 can be trusted not to leak the key.) Such private and public key pairs can be generated using any known key pair generation technique, such as the techniques used to generate key pairs for incorporation into digital certificates that are used to verify authenticity of websites or emails. Each token T thus includes a public key PuK and a private key PrK. Each token T is also associated with a particular time stamp TS. As will be explained in greater detail below, the public keys PrK are available to server 54 at a time that is in advance of a particular time stamp TS actually passing, while the private keys PrK are only made available to client machines 62 at a time that corresponds to, or is subsequent to, a particular time stamp TS actually occurring. The foregoing is represented in FIG. 2 (and where applicable to other Figures) by showing link 74 disconnected from network 66, while being connected to link 70. (It is to be understood that this representation is for convenience in order to assist in explanation).

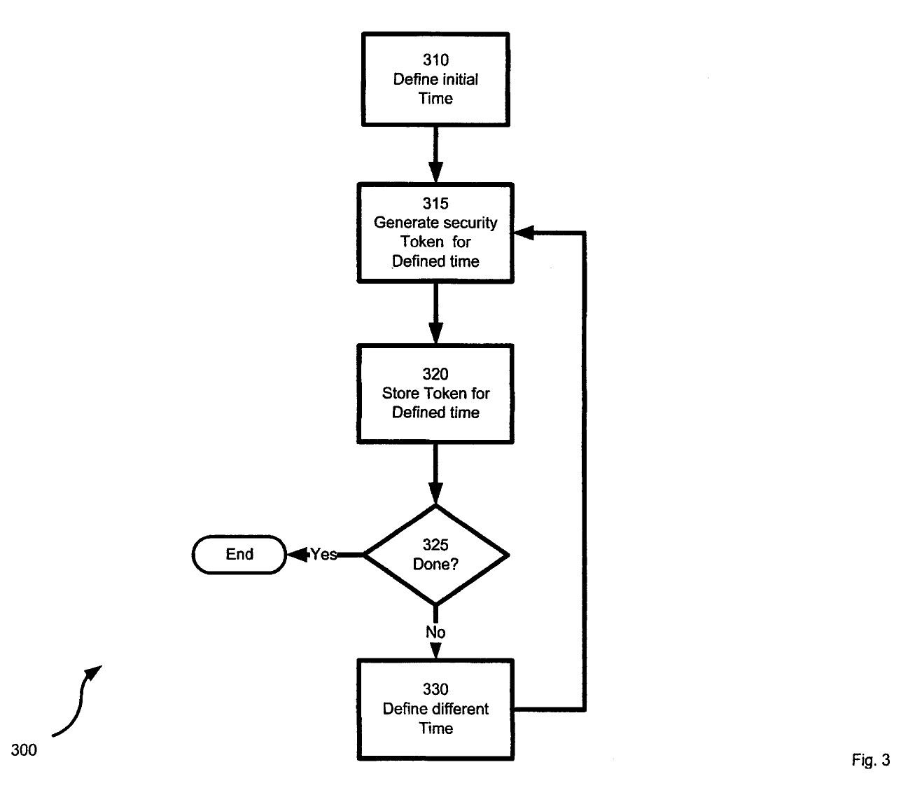

Referring now to FIG. 3, tokens T can be generated according to the flow-chart representing a method for generating tokens and indicated generally at 300. In a present embodiment, method 300 is performed by server 58, but this is not required. At step 310 an initial time stamp is defined. The initial time stamp is typically set to a point in the future from time that method 300 is actually performed. At step 315 a security token is generated. In the present embodiment, the security token comprises a private key PrK and a public key PuK which is generated using known techniques, as previously-discussed. At step 320, the token generated at step 315, including the time stamp associated with the generation of the token, is stored. Next at step 325, a determination is made as to whether a desired number of tokens have been generated. If so, method 300 ends. If not, at step 330 another time is defined and the method returns to step 315. The other time defined at step 330 is also typically set to a point in the future from the time that step 330 is actually performed. One way to implement step 330 is to simply increment from the initial time defined at step 310 by a predefined interval, such as one minute, one hour, or one day, as desired. Subsequent performances of step 330 would simply continuing incrementing the time stamp by the predefined interval.

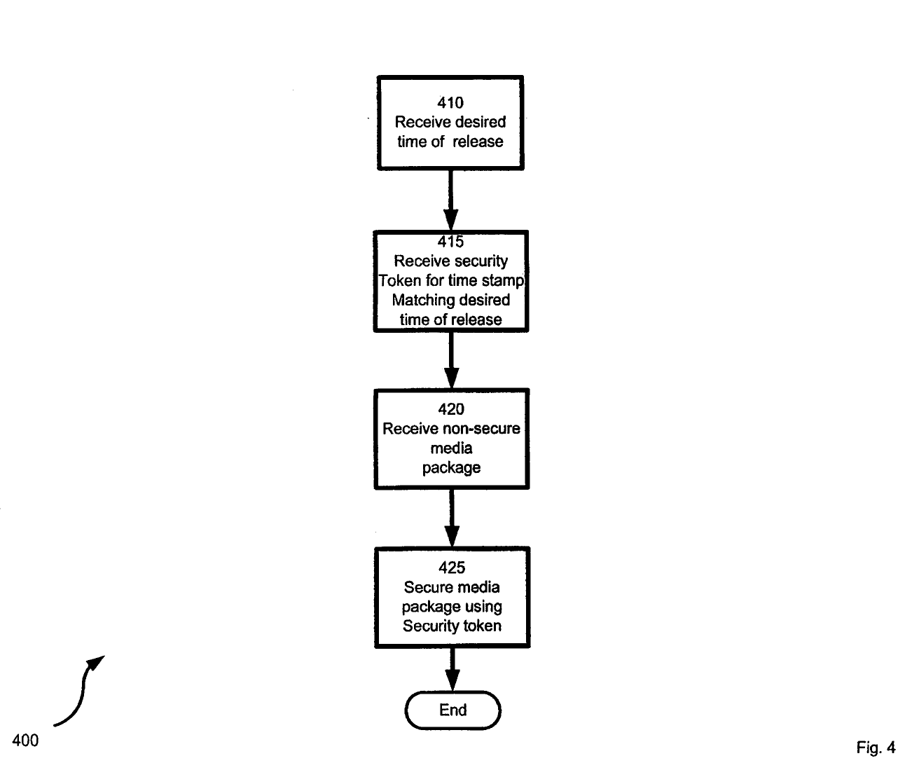

Referring now to FIG. 4, secure versions of media packages M can be generated according to the flow-chart representing a method for securing media packages and indicated generally at 400. In a present embodiment, method 400 is performed by server 54, but this is not required. Beginning first at step 410, a desired time of release is received. The desired time of release can be based on any factors. Typically, such factors are associated with the nature of the media package M. For example, if the media package M is a new movie, then the time stamp will correspond to a release date for the new movie that has been set by the media provider 90, which in this example could be a movie studio or distribution company that is releasing the movie. As another example, if the media package M is a press release containing corporate earnings in which case the media provider 90 can be the corporation issuing the press release, then the time stamp can be chosen to correspond with a date and time that complies with securities regulations. Those skilled in the art will now recognize that since the nature of media package M is not particularly limited, then likewise, the selection of a time stamp to be associated with a release of that media package M is also not particularly limited.

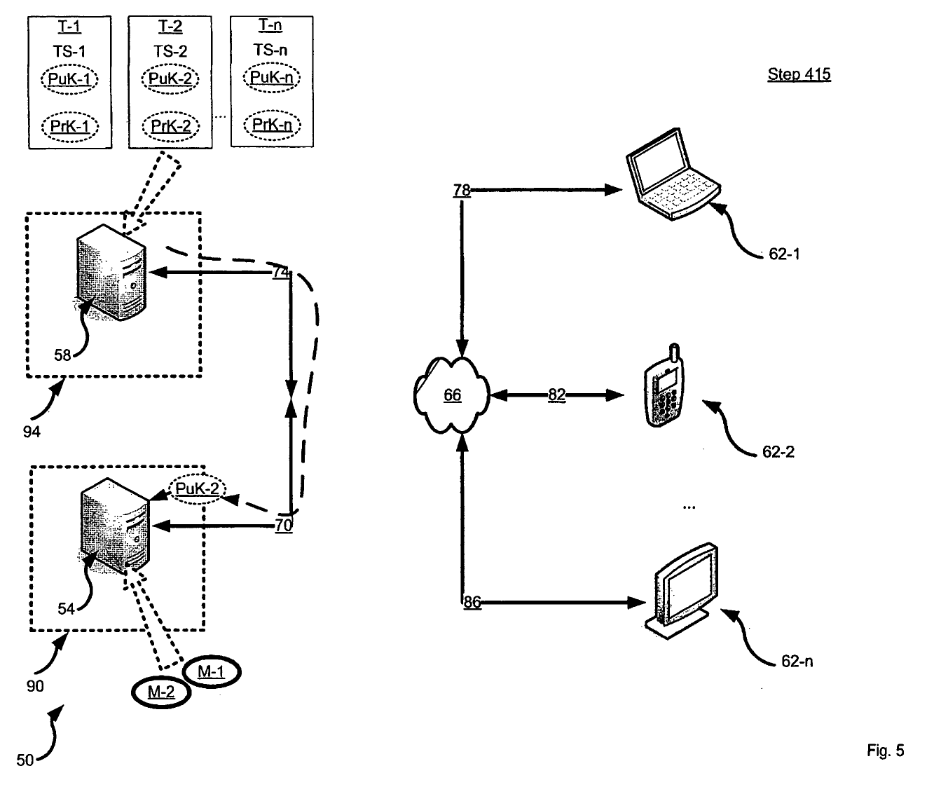

To assist in explaining method 400, an example is helpful. Assume that media package M-1 is to be released at time stamp TS-2. Accordingly, at step 410, a time that matches TS-2 will be received at server 54. Next, at step 415 a security token respective to the time stamp from step 410 will be received. In the present example relative to system 50, server 54 will thus request a copy of public key PuK-2 from server 58, and download public key PuK-2 to server 54, as represented in FIG. 5. To demonstrate connection from server 54 to server 58, (and to represent that media packages M are not available to client machines 62) link 70 is shown as directly connected to link 74.

Next, at step 420, the non-secure media package is received. In the example shown in relation to system 50, step 420 has effectively already occurred as media package M-1 is already shown stored on server 54.

Next, at step 425, the non-secure media package is secured using the security token received at step 415. In a present embodiment, an encrypted version of media package M-1 is generated using public key PuK-2.

Method 400 can then be repeated for media package M-2. Once media packages M have been secured, they can then be made available for delivery to client machines 62 at a time in advance of the actual time stamp associated with the secured version of each media package.

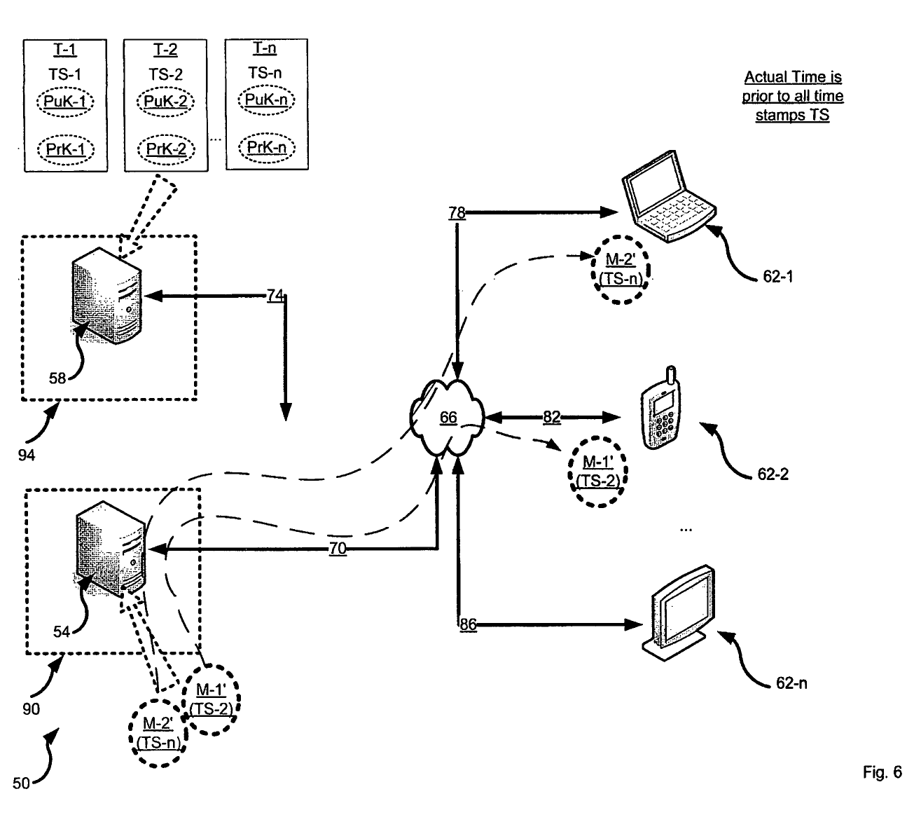

FIG. 6 represents a state of system 50 at an actual time that is prior to the time specified in all of the time stamps TS, but after the performance of method 400 on both media packages M. In FIG. 6, media packages M are now drawn within doffed-line ovals and marked as M-1′ and M-2′, in order to represent secure versions of media packages M′. Also, server 54 is also now shown reconnected to network 66 so that media packages M′ are deliverable to client machines 62. To further illustrate this point, media package M-1′ is shown as having been downloaded to client machine 62-2, while media package M-2′ is shown as having been downloaded to client machine 62-1. Of note is that while media package M-1′ is now resident on client machine 62-2, and media package M-2′ is now resident on client machine 62-1, those media packages M′ are not actually playable (or otherwise usable) since they are in encrypted form.

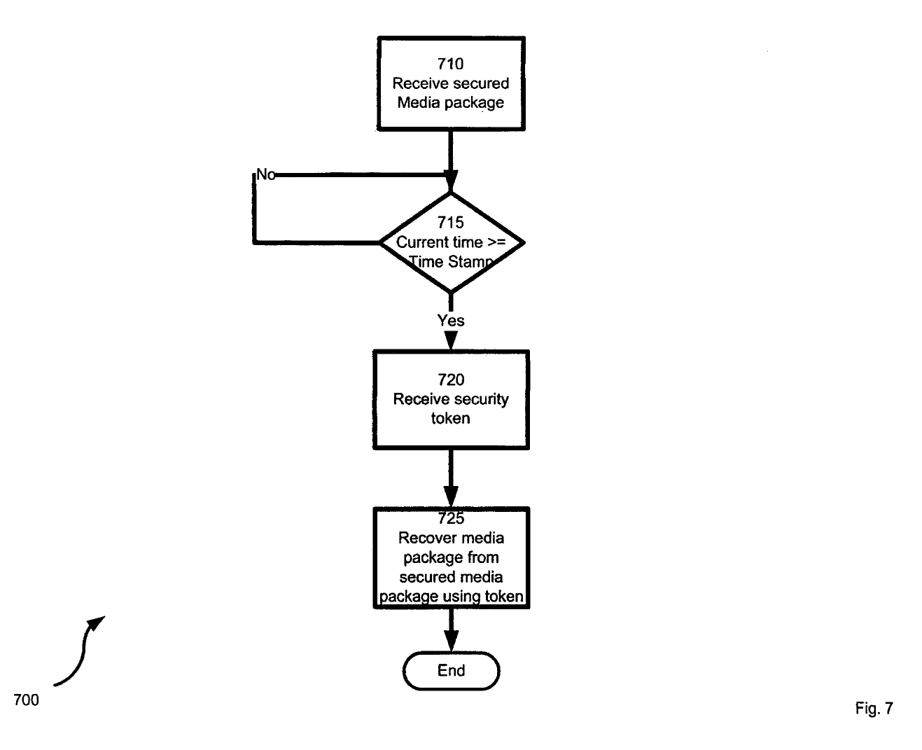

Referring now to FIG. 7, secure versions of media packages M′ can be converted into playable (or otherwise usable) versions of media packages M according to the flow-chart representing a method for recovering secured media packages and indicated generally at 700. At step 710, a secured media package is received. Exemplary performance of step 710 has been previously represented in FIG. 6, where media package M-1′ is shown as having been downloaded to client machine 62-2, while media package M-2′ is shown as having been downloaded to client machine 62-1.

Next, at step 715, a determination is made as to whether the current time is equal to or past the time stamp associated with the secure media package received at step 710. This step can be performed by various components in system 50 and in various ways. In a present example, step 715 is performed automatically by the relevant client machine 62. If the determination at step 715 is “no” then method 700 cycles back to step 715. Once a “yes” determination is made at step 715, method 700 will advance to step 720. At step 720, a security token corresponding to the time stamp associated with the secured media package is received.

(In other embodiments, it should be understood that at least some portions of method 700 could be performed by other components. For example, step 715 could be performed by server 58, and step 720 could also be performed by server 58, which could send the security token to the relevant client machine without waiting for a request from the client machine 62.)

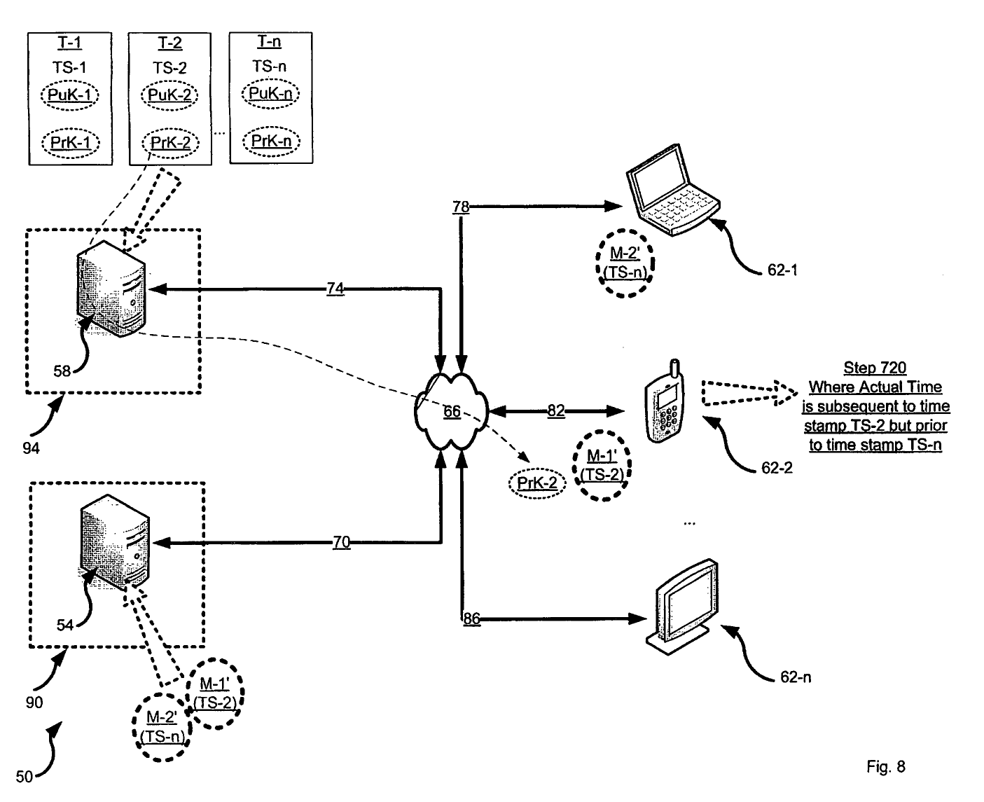

To illustrate exemplary performance of step 720, assume that the actual time is equal to time stamp TS-2, but prior to time stamp TS-n. FIG. 8 reflects the state of system 50 according to this example, whereby client machine 62-2 has downloaded private key PrK-2 from server 58. Also in according to this example, however, client machine 62-1 is still unable obtain private key PrK-n from server 58 since the actual time is still prior to time stamp TS-n.

Referring again to FIG. 7, at step 725 the media package M is recovered from the secured media package M′ using the token received at step 720. On system 50, step 725 is performed by using standard decryption techniques using the encrypted version of media package M′ and applying an appropriate computing operation to media package M′ in conjunction with private key PrK-n in order to finally recover the original media package M.

Upon performance of step 725, method 700 ends.

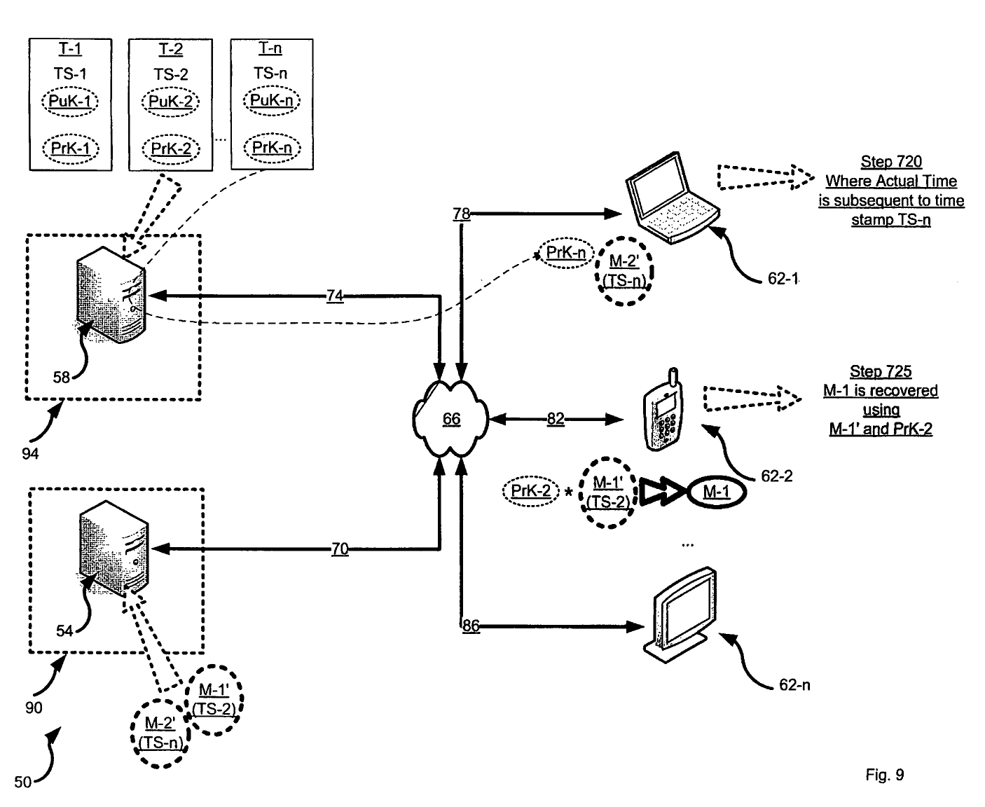

To help further illustrate exemplary performance of step 720 and step 725, assume that the actual time is equal to time stamp TS-n, and after time stamp TS-2. FIG. 9 reflects the state of system 50 according to this example, whereby client machine 62-2 is performing step 725 in order to recover media package M-1 using private key PrK-2 and secure media package M-1. Likewise, FIG. 9 reflects the state of system 50 according to this example, whereby client machine 62-1 is performing step 720 and is receiving private key PrK-n. Thereafter, client machine 62-1 can also perform step 725 in order to recover media package M-2. (Note that performance of method 700 on each client machine 62 is completely independent from each other and that simultaneous performance of method 700 in the Figures is not intended to denote any dependence.)

Thus, once media package M-1 is recovered and once the current time passes time stamp TS-2, then client machine 62-2 can actually play (or otherwise use or access) that recovered media package M-1 in the usual manner. Likewise, once media package M-2 is recovered once the current time passes time stamp TS-n then client machine 62-1 can actually play (or otherwise use) that media package M-2 in the usual manner.

While different advantages to the foregoing will occur to those skilled in the art, one advantage is that download of a given secure media package M′ to a plurality of client machines 62 can occur asynchronously and thereby present less strain on link bandwidth and server 54 resources than if downloads of media packages M were to occur synchronously at the predetermined time of the release. Instead, less strain occurs to link bandwidth and server 58 resources as a plurality of client machines only need download the relatively small private key PrK associated with the secured version of the media package M at the predetermined time of the release. However, the effect is substantially the same in that controlled time release of a media package M is effected.

The foregoing presents certain exemplary embodiments, but variations or combinations or subsets thereof are contemplated. For example, system 50 can be varied whereby server 58 is used to asynchronously distribute public encryption keys and corresponding private encryption keys at different times for different applications other than those described herein in relation to server 54 or client machines 62 or both. As another variation, it should be understood that client machines 62 need not actually obtain secure media packages M′ via network 66, but that secure media packages M′ and private keys PrK can be loaded onto client machines 62 in other ways, such as via universal serial bus (“USB”) pen drives or other removable media. As another variation, embodiments can be modified so that media server 54 or security server 58 or both operate in a broadcast communication mode, whereby media respective to server 54 and encryption tokens respective server 58 travel out from those servers. For example, encrypted media packages M′ files can be sent from server 54 to be posted on other servers (not shown) or otherwise be available for any client machine 62 to obtain. Likewise, the relevant private key private key PrK would be sent at the appropriate time to be posted on other servers or otherwise be available for any client machine 62 to obtain. Alternatively, a hybrid approach can be employed whereby either the media packages M′ or the private key PrK would be broadcast at the appropriate time.

1. A security server comprising a computing environment including a module that houses one or more central processing units, volatile memory, persistent memory and a network interface; said security server configured to generate a plurality of security tokens and time stamps associated with each of said security tokens; said time stamps representing times after generation of said security tokens.

2. The security server of claim 1 wherein said server is further configured to permit a media server access to at least one of said security tokens a time prior to a time identified by the time stamp that is respective to said at least one of said security tokens.

3. The security server of claim 1 wherein each security token includes a public encryption key and a private encryption key and said time stamp; said security server is configured to permit a media server access to said public encryption key at a time prior to a time identified by the time stamp that is respective to said at least one of said public encryption key.

4. The server of claim 1 wherein said server is further configured to only permit a client machine to access at least one of said security tokens a time equal to or after a time identified by the time stamp that is respective to said at least one of said security tokens.

5. The security server of claim 1 wherein each security token includes a public encryption key and a private encryption key and said time stamp; said security server is configured to permit a client machine to access to said private encryption key at a time equal to or after a time identified by the time stamp that is respective to said private encryption key.

6. A media server comprising a computing environment including a module that houses one or more central processing units, volatile memory, persistent memory and a network interface; said media server configured to obtain at least a portion of security token and generate a secure version of a media package; said security token associated a time stamp that represents a time that occurs after a time at which said secure version is generated.

7. The media server of claim 6 wherein said media server is further configured to upload said secure version of said media package to a plurality of client machines at a time that is prior to said time stamp.

8. The media server of claim 6 wherein each security token includes a public encryption key and a private encryption key and said portion of said security token is said public encryption key.

9. A client machine comprising a computing environment including an input device, an output device and a chassis to which the input device and the output device are connected; said chassis housing one or more central processing units, volatile memory, persistent memory and an interface interconnected via a bus; said interface for receiving a secure media package at a time prior to a predefined release; said client machine configured for receiving at least a portion of a security token at time equal to or after said predefined release; said client machine configured to recover a media package from said secure media package using said at least a portion of a security token.

10. The client machine of claim 9 wherein each security token includes a public encryption key and a private encryption key and said portion of said security token is said private encryption key.

11. The client machine of claim 9 wherein said client machine is one of a laptop computer, desktop computer, mobile computing device, or a television.

12. The client machine of claim 9 wherein said interface is a network interface.

13. The client machine of claim 9 wherein said interface is a port for receiving removable media; said removable media for storing said secure media package.

14. A method for generating security tokens comprising:
defining an initial future time;
generating a security token that is associated with said defined time; and,
storing said security token for said defined time.

15. The method of claim 14 further comprising defining another future time other than said initial future time and repeating said generating and storing.

16. The method of claim 15 wherein said defining said another future time comprises adding a predefined interval to said initial future time.

17. The method of claim 15 comprising repeating said method for a plurality of different defined times.

18. The method of claim 15 wherein each said security token includes a public encryption key and a private encryption key.

19. A method for generating a secure media package comprising:
receiving a desired time of release for said secure media package;
receiving at least a portion of a security token associated with a time stamp that matches said desired time of release;
receiving a media package; and,
generating a secure media package using said at least a portion of a security token and said media package.

20. The method of claim 19 wherein said security token comprises a public encryption key and a private encryption key and said portion is said public encryption key.

21. The method of claim 19 wherein said media package is one of a press release, a television program or a movie.

22. The method of claim 19 further comprising uploading said secure media package to one or more client machines prior to said desired time of release.

23. A method of recovering a media package comprising:
receiving a secured media package having a desired time of release for said secure media package;
determining if a current time is equal to or past said desired time;
if said current time is equal to or past said desired time, receiving at least a portion of a security token associated with a time stamp that matches said desired time of release; and,
recovering a media package using said at least a portion of a security token and said secure media package.

24. The method of claim 23 wherein said security token comprises a public encryption key and a private encryption key and said portion is said private encryption key.

25. The method of claim 23 wherein said media package is one of a press release, a television program or a movie.
